(19) United States
(12) Patent Application Publication
(10) Pub. No.: US 2009/0035637 A1
(43) Pub. Date: Feb. 5, 2009

(54) Anode supported solid oxide fuel cell

(75) Inventors: Joongmyeon Bae, Daejeon (KR); Seung-Wook Baek, Gyeongsangnam-do (KR)

Correspondence Address: THE WEBB LAW FIRM, P.C., 700 KOPPERS BUILDING, 436 SEVENTH AVENUE, PITTSBURGH, PA, 15219, US

(73) Assignee: Korea Advanced Institute of Science and Technology, Daejeon (KR)

(21) Appl. No.: 11/943,500

(22) Filed: Nov. 20, 2007

(30) Foreign Application Priority Data
Jul. 30, 2007 (KR) 10-2007-0076487

(51) Int. Cl. H01M 8/10

(52) U.S. Cl. 429/30

(57) ABSTRACT

The present invention relates to a solid oxide fuel cell in which an anode is formed with a current collecting hole and a reinforcement hole, and a current collecting member and a reinforcement member are respectively in the current collecting hole and reinforcement hole, thereby increasing a current collecting efficiency and thus an efficiency of producing electric energy and also improving a cell strength. The solid oxide fuel cell has an electrolyte layer; an anode and a cathode formed to be contacted with both surfaces of the electrolyte layer; a current collecting hole formed in the anode; and a current collecting member inserted into the current collecting hole.

### TECHNICAL FIELD

The present invention relates to a solid oxide fuel cell (SOFC), and more particularly, to a solid oxide fuel cell in which an anode is formed with a current collecting hole and a reinforcement hole, and a current collecting member and a reinforcement member are respectively in the current collecting hole and reinforcement hole, thereby increasing a current collecting efficiency and thus an efficiency of producing electric energy and also improving a cell strength.

### BACKGROUND ART

A fuel cell, which directly converts chemical energy generated by oxidation into electrical energy, is a new green futuristic energy technology which can generates the electrical energy from materials such as oxygen, hydrogen and the like which is found in abundance on the earth.

In the fuel cell, oxygen is supplied to a cathode and hydrogen is supplied to an anode so that an electrochemical reaction is performed in a reverse way of water electrolysis so as to generate electricity, head and water, thereby producing the electrical energy without any contaminants.

Since the fuel cell is free from limitation of Carnot cycle efficiency which acts as the limitation in a conventional heat engine, it is possible to increase an efficiency of 40% or more. Further, since only the water is exhausted as emissions, there is not a risk of environmental pollution. Furthermore, since there is not a necessity of a place for mechanical motion, unlike in the conventional heat engine, it has some advantages of reducing a size and a noise. Therefore, the fuel cell technologies (e.g. material, fabrication, etc) are actively investigated at many famous laboratories all over the world at present.

According to a kind of electrolyte used therein, the fuel cell is classified into a PAFC (Phosphoric Acid Fuel Cell), a MCFC (Molten Carbonate Fuel Cell), a SOFC (Solid Oxide Fuel Cell), a PEMFC (Polymer Electrolyte Membrane Fuel Cell), a DMFC (Direct Methanol Fuel Cell) and an AFC (Alkaline Fuel Cell) which are already being used or developed. Characteristics thereof will be described in a table.

| | PAFC | MCFC | SOFC | PEMFC | DMFC | AFC |
|---|---|---|---|---|---|---|
| Electrolyte | Phosphoric | Lithium | Zirconia/ | Hydrogen | Hydrogen | Potassium |
| | acid | carbonate/ | Ceria | ion | ion | hydroxide |
| | | Potassium | series | exchange | exchange | |
| | | carbonate | | membrane | membrane | |
| Ion | Hydrogen ion | Carbonic | Oxygen | Hydrogen | Hydrogen | Hydrogen |
| conductor | | acid ion | ion | ion | ion | ion |
| Operation | 200 | 650 | 500~1000 | <100 | <100 | <100 |
| temperature | | | | | | |
| Fuel | Hydrogen | Hydrogen, | Hydrogen, | Hydrogen | methanol | Hydrogen |
| | | carbon | hydrocarbon, | | | |
| | | monoxide | carbon | | | |
| | | | monoxide | | | |
| Raw | City gas, | City gas, | City gas, | Methanol, | methanol | Hydrogen |
| material of | LPG | LPG, coal | LPG, | Methane | | |
| fuel | | | Hydrogen | gasoline, | | |
| | | | | Hydrogen | | |
| Efficiency | 40 | 45 | 45 | 45 | 30 | 40 |
| (%) | | | | | | |
| Range of | 100-5000 | 1000-1000000 | 100-100000 | 1-10000 | 1-100 | 1-100 |
| output | | | | | | |
| power (W) | | | | | | |
| Application | Distributed | Large | Small, | Power | Portable | Power |
| | power | scale | middle | source | power | source for |
| | generation | power | and large | for | source | space ship |
| | | generation | scale | transport | | |
| | | | power | | | |
| | | | generation | | | |
| Development | Demonstrated- | Tested- | Tested- | Tested- | Tested- | Applied to |
| level | utilized | demonstrated | demonstrated | demonstrated | demonstrated | space ship |

[symbol]

As described in the table, the fuel cells have various ranges of output power and applications and the like. Thus, a user can selectively use one of the fuel cells for various purposes. Particularly, the SOFC has a disadvantage that its operation temperature is high, but also has an advantage that it can be used for large scale power generation.

FIG. 1 is a view showing an operation principle of the SOFC, wherein oxygen is supplied to the cathode and hydrogen is supplied to the anode. At this time, the reaction is performed as follows:

Reaction in the anode:

2H₂+2O²⁻→2H₂O+4e⁻

Reaction in the cathode:

O₂+4e⁻→2O₂₋

In the SOFC having the characteristic described above, the higher the diffusion performance of the hydrogen supplied to the anode is, the more an efficiency of the fuel cell is increased. Therefore, in order to increase the diffusion performance of the hydrogen supplied to the anode, a gas diffusion layer is formed by artificially adding an additive like polymer or carbon.

In the conventional SOFC, since pores are formed by adding the additive to the gas diffusion layer, strength of the SOFC is reduced. But if a thickness of the anode is increased in order to solve the problem, gas diffusion is deteriorated, and thus a performance of the fuel cell is also deteriorated. Particularly, the performance of the fuel cell is damaged in a high current range.

Further, according as the reaction is processed, a gas diffusion path is clogged by carbon deposition. Thus, fuel supplying to a catalytic layer contacted with an electrolyte layer is blocked. Since it makes difficult to collect current generated from the anode, there is a problem of electric power loss.

### DISCLOSURE OF THE INVENTION

It is an object of the present invention to provide a solid oxide fuel cell in which an anode is formed with a current collecting hole and a current collecting member is inserted into the current collecting hole so as to rapidly collect the generated electrons and thus reduce a loss of the electrons, and also a current collecting layer connected with the current collecting member is formed at an outer surface of the anode so as to increase a contact surface, thereby increasing the current collecting efficiency.

It is another object of the present invention to provide a solid oxide fuel cell in which the anode is further formed with a reinforcement hole and a reinforcement member is inserted in the reinforcement hole, thereby improving a cell strength.

To achieve the object, there is provided a solid oxide fuel cell comprising an electrolyte layer 10; an anode 20 and a cathode formed to be contacted with both surfaces of the electrolyte layer 10; a current collecting hole 21 formed in the anode 20; and a current collecting member 22 inserted into the current collecting hole 21.

Preferably, a current collecting layer 23 connected with the current collecting member 22 is further provided at an outer surface of the anode 20.

Preferably, a reinforcement hole 24 is further provided, and a reinforcement member 25 is inserted into the reinforcement hole 24.

Preferably, the current collecting hole 21 or the reinforcement hole 24 is longitudinally formed in the anode 20.

Preferably, the current collecting hole 21 or the reinforcement hole 24 is laterally formed in the anode 20.

Preferably, the current collecting hole 21 or the reinforcement hole 24 is formed into a continuous channel type path.

Further, according to the present invention, there is provided a solid oxide fuel cell comprising an electrolyte layer 10; an anode 20 and a cathode formed to be contacted with both surfaces of the electrolyte layer 10; a reinforcement hole 24 formed in the anode 20; and a reinforcement member 25 inserted into the reinforcement hole 24.

### BRIEF DESCRIPTION OF THE DRAWINGS

FIG. 1 is a schematic diagram showing an operation principle of a solid oxide fuel cell (SOFC).

FIG. 2 is a perspective view of an SOFC according to an embodiment of the present invention.

FIG. 3a is a cross-sectional view taken along a line A-A′ of FIG. 2.

FIG. 3b is a cross-sectional view taken along a line B-B′ of FIG. 2.

FIG. 4a is a perspective view of an SOFC according to another embodiment of the present invention.

FIG. 4b is a cross-sectional view of FIG. 4a.

FIG. 5 is a cross-sectional view of an SOFC according to yet another embodiment of the present invention.

FIG. 6 is a cross-sectional view of an SOFC according to yet another embodiment of the present invention.

FIG. 7 is a cross-sectional view of an SOFC according to yet another embodiment of the present invention.

FIG. 8 is a photograph showing the SOFC according to the present invention.

### DETAILED DESCRIPTION OF MAIN ELEMENTS

100: solid oxide fuel cell (SOFC)
10: electrolyte layer
20: anode
21: current collecting hole
22: current collecting member
23: current collecting layer
24: reinforcement hole
25: reinforcement member
30: cathode

### BEST MODE FOR CARRYING OUT THE INVENTION

Practical and presently preferred embodiments of the present invention are illustrative with reference to the accompanied drawings.

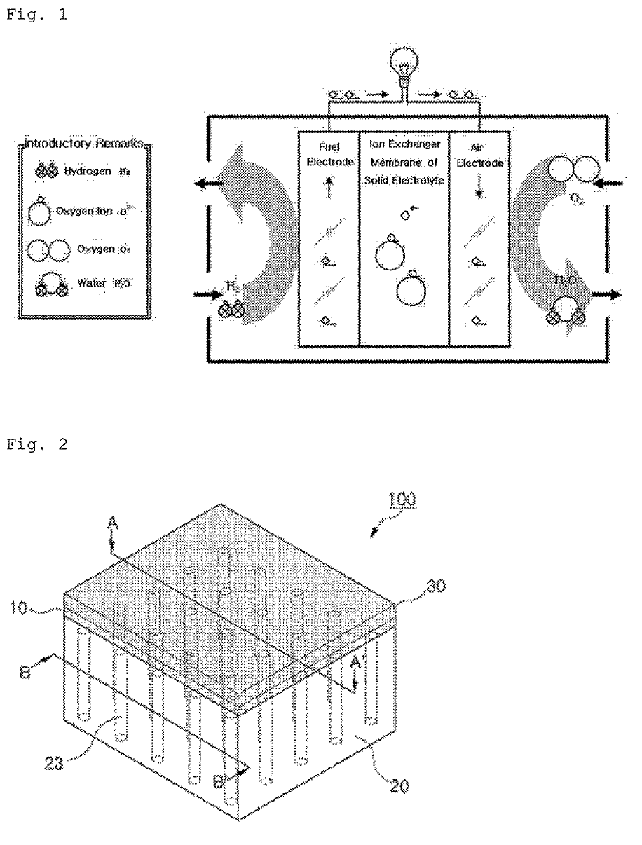

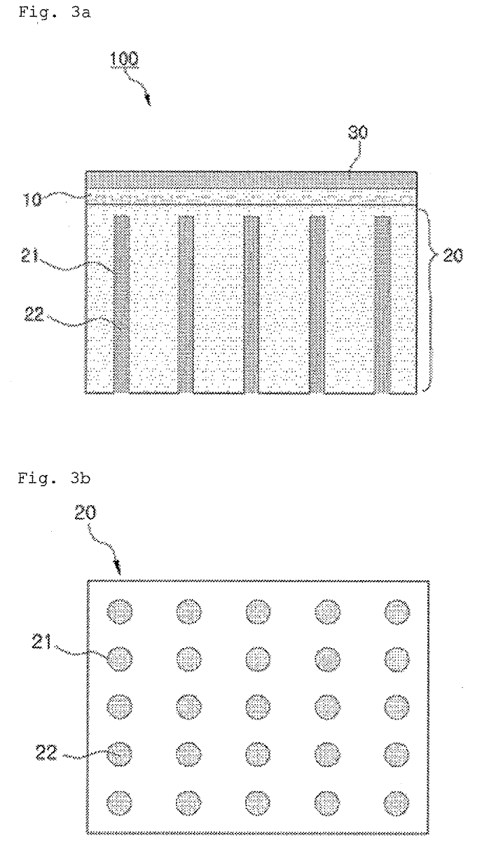

FIG. 2 is a perspective view of an SOFC according to an embodiment of the present invention, FIG. 3a is a cross-sectional view taken along a line A-A′ of FIG. 2, and FIG. 3b is a cross-sectional view taken along a line B-B′ of FIG. 2.

As shown in FIGS. 2 to 3b, the SOFC 100 includes an electrolyte layer 10, an anode 20 and a cathode 30, and the anode 20 is formed with a current collecting hole 21, and a current collecting member 22 is inserted into the current collecting hole 21.

The anode 20 and the cathode 30 are formed to be contacted with both surfaces of the electrolyte layer 10. Since an efficiency of the fuel cell is influenced by facility of supplying fuel gas to the electrolyte layer 10, the anode 20 is typically formed of a porous material. In case that the anode 20 is formed of the porous material, a loss of generated electric energy is occurred. Further, the current collecting in the fuel cell is performed by putting a current collector to a lower side of the cell. However, during the current collecting process, the electric power loss is occurred and it leads to the deterioration of the performance of the fuel cell.

The present invention is to solve the above problem. In the SOFC 100 of the present invention, the current collecting hole 21 is formed at the anode 20, and the current collecting member 22 is inserted into the current collecting hole 21 so as to directly collect the current in the cell, thereby increasing the current collecting efficiency.

In the SOFC 100 shown in FIGS. 2 to 3b, the current collecting holes 21 is longitudinally formed in plural, and the current collecting member 22 is inserted into each of the current collecting holes 21.

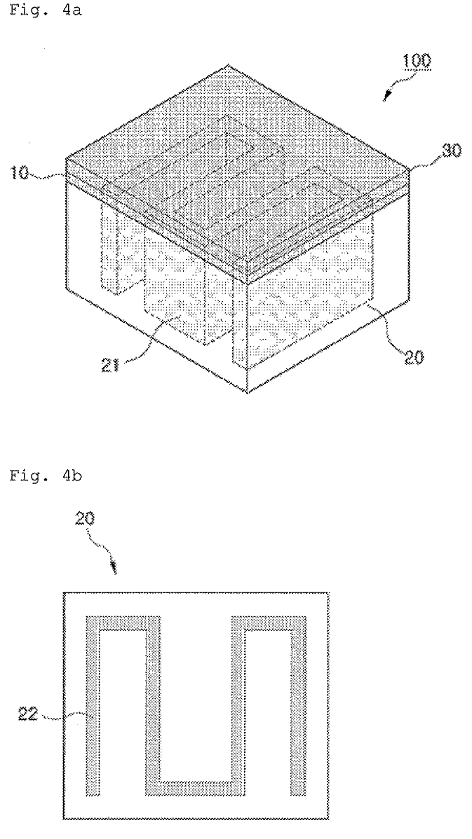

FIG. 4a is a perspective view of an SOFC 100 according to another embodiment of the present invention, FIG. 4b is a cross-sectional view of FIG. 4a. In the SOFC 100 shown in FIGS. 4a and 4b, the current collecting hole 21 is formed into a channel type so as to have a continuous path.

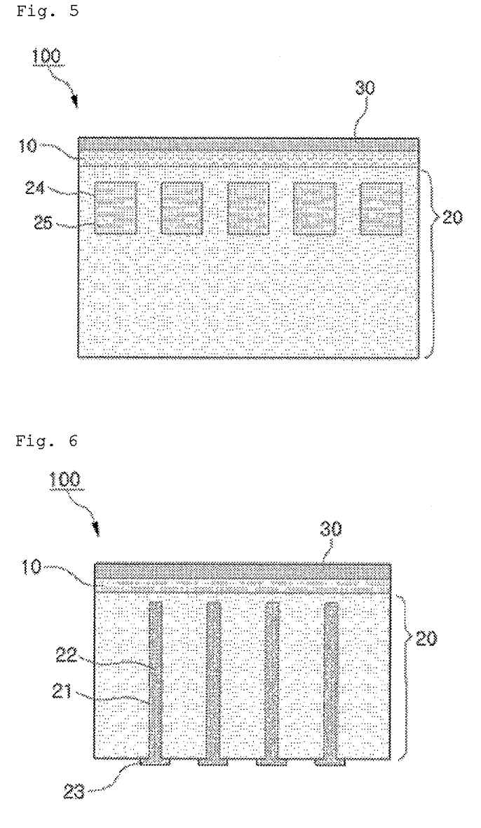

FIG. 5 is a cross-sectional view of an SOFC according to yet another embodiment of the present invention. Referring to FIG. 5, a reinforcement hole 24 is laterally formed in the anode 20, and a reinforcement member 25 is inserted into the reinforcement hole 24. The reinforcement hole 24 may be longitudinally formed in plural and also have various shapes and sizes according to a characteristic of the anode 20.

Meanwhile, FIG. 6 is a cross-sectional view of an SOFC according to yet another embodiment of the present invention. A current collecting layer 23 extended from the current collecting member 22 may be further provided at an outer surface of the anode 20 so that electrons can be facilely moved to the outside of the cell through the current collecting member 22 and the current collecting layer 23, thereby further increasing the current collecting efficiency.

FIG. 6 shown an example that the current collecting layer 23 connected with the current collecting member 22 is provided in plural. The current collecting layer 23 can be formed by screen printing, sputtering, metal spraying and the like.

The current collecting member 22 which is inserted into the current collecting hole 21 may be formed of a single metal like Ni, or a Cermet in which metal and ceramic are mixed. In other words, the current collecting member 22 may be formed of Ni, Ce-based oxide, YSZ-based oxide or a mixture of the Ni, Ce-based oxide and YSZ-based oxide. At this time, it is preferable that the ceramic is the same as that forming the anode 20. A current collecting performance can be controlled by controlling a content of NiO.

FIG. 7 is a cross-sectional view of an SOFC according to yet another embodiment of the present invention. The SOFC 100 of the present invention is provided with a reinforcement hole 24 as well as the current collecting hole 21, and a reinforcement member 25 is inserted into the reinforcement hole 24.

According to the present invention, the reinforcement hole 24 and the reinforcement member 25 are formed in the anode 20, thereby increasing strength of the anode 20.

The reinforcement member 25 may be formed of a single metal like Ni, or a Cermet in which metal and ceramic are mixed. Preferably, the ceramic is the same as that forming the anode 20 so as to minimize a thermal deformation and also prevent a reaction between the reinforcement member 25 and the anode 20.

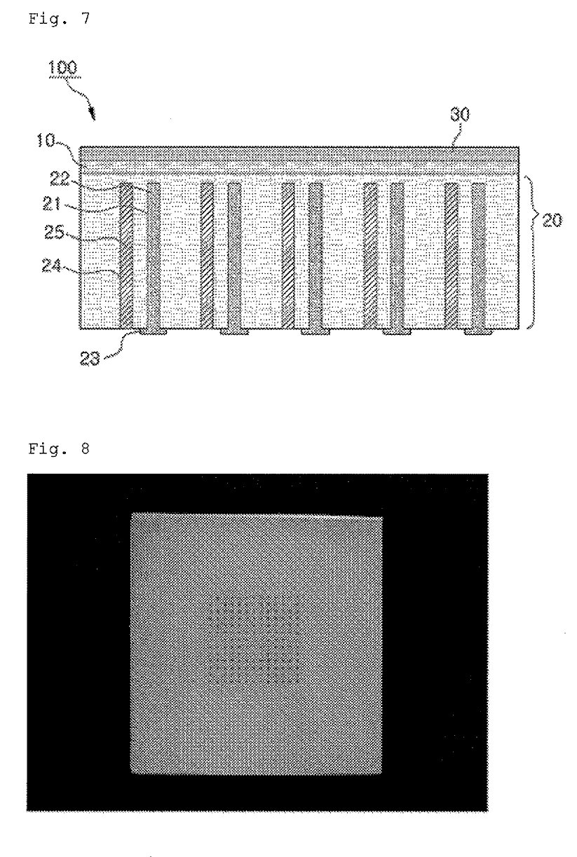

FIG. 8 is a photograph showing the SOFC according to the present invention, wherein a plurality of holes are longitudinally formed in the anode 20. The holes are used as the current collecting hole 21 or the reinforcement hole 24 according to a kind of material to be inserted therein.

The current collecting member 22 and the reinforcement member 25 may be formed into various types according to its fabricating method. The current collecting hole 21 or the reinforcement hole 24 is formed at the anode 20, and the current collecting member 22 or the reinforcement member 25 which is formed into a bar type is inserted therein.

In case that the anode 20 is formed in a sheet stacking method, the holes are formed in each sheet and the reinforcement member 24 or the current collecting member 22 is filled into each of the holes before the stacking of sheets and then the stacking and heat-treating processes are performed.

### INDUSTRIAL APPLICABILITY

According to the SOFC of the present invention, the fuel cell is provided with the current collecting hole and the current collecting member is inserted into the current collecting hole, thereby reducing a loss of electrons, rapidly collecting the current and thus increasing an efficiency of producing electric energy. And the anode is further formed with the reinforcement hole and the reinforcement member is inserted into the reinforcement hole, thereby obtaining a mechanical strength for supporting the SOFC.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

1. A solid oxide fuel cell, comprising:
an electrolyte layer;
an anode and a cathode formed to be contacted with both surfaces of the electrolyte layer;
a current collecting hole formed in the anode; and
a current collecting member inserted into the current collecting hole.

2. The solid oxide fuel cell as set forth in claim 1, wherein a current collecting layer connected with the current collecting member is further provided at an outer surface of the anode.

3. The solid oxide fuel cell as set forth in claim 1, wherein a reinforcement hole is further provided; and a reinforcement member is inserted into the reinforcement hole.

4. The solid oxide fuel cell as set forth in claim 3, wherein the current collecting hole or the reinforcement hole is longitudinally formed in the anode.

5. The solid oxide fuel cell as set forth in claim 3, wherein the current collecting hole or the reinforcement hole is laterally formed in the anode.

6. The solid oxide fuel cell as set forth in claim 4, wherein the current collecting hole or the reinforcement hole is formed into a continuous channel type path.

7. A solid oxide fuel cell, comprising:
an electrolyte layer;
an anode and a cathode formed to be contacted with both surfaces of the electrolyte layer;
a reinforcement hole formed in the anode; and
a reinforcement member inserted into the reinforcement hole.

8. The solid oxide fuel cell as set forth in claim 5, wherein the current collecting hole or the reinforcement hole is formed into a continuous channel type path.
